(19) United States
(12) Patent Application Publication
(10) Pub. No.: US 2008/0059366 A1
(43) Pub. Date: Mar. 6, 2008

(54) Method and system for secure transactions

(76) Inventor: Augustine Fou, New york, NY (US)

Correspondence Address: CHARLES A. RATTNER, 12 HOMEWOOD LANE, DARRIEN, CT, 06820-6109, US

(21) Appl. No.: 11/894,859

(22) Filed: Aug. 22, 2007

Related U.S. Application Data
(63) Continuation-in-part of application No. 10/653,391, filed on Sep. 2, 2003.
(60) Provisional application No. 60/839,238, filed on Aug. 22, 2006.

(51) Int. Cl. G06Q 40/00

(52) U.S. Cl. 705/39

(57) ABSTRACT

As an alternative to paper check processing, the methods and systems now introduced include processing transactions from bank account to bank account while providing the parties involved with greater privacy and protections against identity theft, check fraud, and other types of potential fraud. Each party is provided with a unique code that can be entered, for example, at a website, in place of their actual account details. The website uses stored account identification details to process a payment from one party to the other.

### CROSS-REFERENCE TO RELATED APPLICATIONS

This application claims priority under 35 U.S.C. §119 to U.S. Provisional Patent Application Ser. No. 60/839,238 entitled “METHOD AND SYSTEM FOR TRANSACTIONS” filed in the name of Augustine Fou on Aug. 22, 2006, the entirety of which is herein incorporated by reference. This application further claims priority under 35 U.S.C. §120 as a continuation-in-part of co-pending U.S. patent application Ser. No. 10/653,391 entitled “METHOD FOR FACILITATING COMMERCIAL PROGRAMS INVOLVING CONSUMER PRODUCTS USING UNIVERSALLY UNIQUE ITEM IDENTIFIERS” filed in the name of Augustine Fou on Sep. 2, 2003, the entirety of which is herein incorporated by reference.

### TECHNICAL FIELD

This disclosure relates generally to data processing for financial transactions, and more particularly, to funds transfers such as bill payments.

### BACKGROUND OF THE DISCLOSURE

Small businesses represent 99.7% of the number of businesses in the United States, an estimated $4.7 trillion in total spending, as well as one-third of all expenditures by businesses (source: Visa), adding 75% of net new jobs to the economy (source: Small Business Administration). The largest share of small business expenditures, 34 percent or approximately $1.6 trillion, is comprised of payments for “core business services,” such as legal, accounting, insurance and shipping and mailing expenditures.

However, credit cards account for only 3% of all small business spending overall, with the remaining 97% being transacted by cash and check. Divisions of companies, like OPEN from AMERICAN EXPRESS, or companies focused entirely on small business credit cards, such as ADVANTA, have seen incredible growth over the last several years in issuing small business cards relative to consumer cards, the market for which is massively oversaturated. Despite this recent growth, small business issuers are finding it increasingly difficult to shift spending away from cash and check, not to mention the increasing competition from other banks entering this lucrative market with small business cards of their own. To maintain the torrid growth rates, issuers are aggressively increasing spending in marketing and reward programs to attract new customers and increase transaction volume. The costs of these activities are ultimately passed on to card-members in the form of increased fees, such as annual fees, penalties, transaction fees, finance charges, and the like. This most acutely affects small businesses, especially those whose margins and cash flow are tight.

There is also an intense recent public awareness of identity theft, credit card and check fraud, online scams, and computer attacks such as viruses, phishing, and pharming. Many high profile news items, like the recent reports of 40 million credit card numbers being stolen, are causing consumers and small businesses alike to look for ways to protect themselves. Companies that provide services like identity theft protection and credit bureau monitoring have seen a corresponding boom. However, the risk of fraud remains high with one of the most common transaction methods: paper checks. Checking account numbers and bank routing numbers plus complete mailing addresses are printed in human-readable format on every check. This poses a gaping security loophole, especially in light of recent reports of rings of thieves whose modus operandi is stealing letters with checks inside from mailboxes or directly from postal facilities.

Accordingly, there is a need for a system for accomplishing financial transactions, such as those normally conducted by paper check, which is easily implemented in the commercial marketplace and readily useful by payer and payees of financial transactions.

### SUMMARY OF THE DISCLOSURE

The methods and systems for accomplishing a financial transaction now introduced include: registering a payer and a payee with a payment processing service. A unique customer identifier is generated for each payer and payee using the system. Such customer identifiers can only be used by a third party to make a deposit to the bank account corresponding to the customer identifier, and the customer identifier itself does not include an actual bank account number of the payer in human-readable format. In processing a transaction, a request to initiate a payment to a payee is received from a payer. The request includes a unique customer identifier of the payee and a transaction amount. In response, a unique transaction identifier for the payment is provided to the payer for subsequent communication to the payee. The service provider associates the unique transaction identifier with the unique customer identifier of the payee, so that only the payee may use the unique transaction identifier to accomplish a deposit of the payment.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a flowchart depicting an exemplary transaction process performed by a payer, according to the present disclosure;

FIG. 2 is a flowchart depicting an exemplary transaction process performed by a payee, according to the present disclosure;

FIG. 3 is an exemplary screen for registering a customer for the transaction processes of FIGS. 1 and 2;

FIG. 4 is an exemplary screen for initiating a payment in accordance with the transaction process of FIG. 1; and

FIG. 5 is an exemplary screen for making a deposit in accordance with the transaction process of FIG. 2.

### DETAILED DESCRIPTION OF THE DISCLOSURE

The methods and systems for accomplishing financial payments now introduced, sometimes referred to herein as PRIVATECHECK, eliminates the security loopholes of paper checks, reduces the cost of transactions (e.g. handling paper checks, credit card fees, and the like), and protects the identity and sensitive information of small businesses. It is based on point-to-point transactions where verified payers and payees can make and receive payments to and from each other, respectively, without revealing checking account numbers, bank routing numbers, or other sensitive information usually presented on paper checks and the like.

Each transaction, including details necessary to effect the transaction (such as date and time, dollar amount, payer and payee parties, and transaction memos or notes) is uniquely identified by an identifier or code. Both parties can audit transactions for accuracy, using only the provided code, without ever requiring the underlying identity or bank information of the other party that appears on paper checks.

The PRIVATECHECK service eliminates the risk of fraud and identity theft of paper checks, reduces the cost of transactions (e.g. check fraud), and reduces costs due to human error. Any customer of a participating bank, financial institution or other service provide, can sign up for the service. Once verified, each customer receives a unique PRIVATECHECK identifier, which they use for making and receiving payments without revealing their sensitive banking information to payee parties. Each transaction is also uniquely identified with, for example, a single-use alphanumeric transaction code which can only be deposited by the intended payee, and is therefore of no use even if intercepted. Deposits are made by copy-and-paste of the transaction code by the payee, thus eliminating the human error associated with re-typing handwritten information from paper checks. Both parties can audit transactions for accuracy, using only the transaction code, without ever requiring the identity or bank information of the other party. Completed transactions can also be downloaded directly into standard accounting software such as QUICKEN or QUICKBOOKS.

The PRIVATECHECK service offers the following benefits: (i) registered and verified customers are uniquely identified by a PrivateCheck Customer Identifier, which can be designated for use only to receive payments, and can therefore be printed publicly on business cards or other publicly disseminated business information; (2) payments are made simply by specifying the payee's PrivateCheck Customer ID and the amount to pay, in response to which a unique, single use transaction code is created; and (3) deposits are made by entry of the transaction code and can only be deposited by the payee, when properly logged-in to the PRIVATECHECK SERVICE. The transaction code is tied to the intended payee in the records of the PRIVATECHECK service, and so can not be used by unintended parties, even if intercepted.

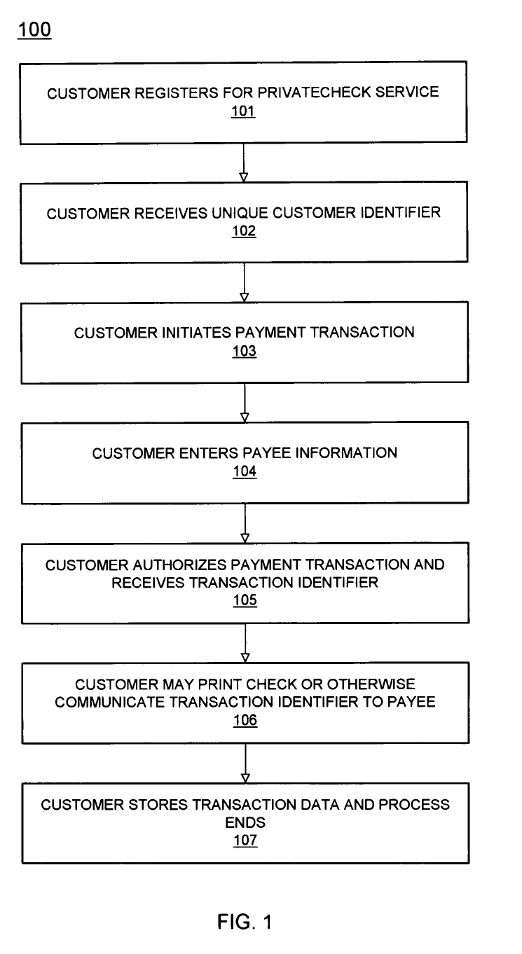

Turning now to FIGS. 1-5, therein are depicted exemplary flowcharts of the processes performed by payers and payees of financial transactions to accomplish a payment, and some exemplary screen shots for entering the information required by such processes. It should be readily apparent that such systems may be implemented over any sort of computer or telecommunications network that is suitable for accomplishing electronic communications and financial transactions, such as the Internet, or any other type of wired or wireless network as now known or hereafter developed. In performing the processes 100, 200, it should be readily apparent that the customers and any third party participants to the processes may communicate using any of a wide variety of well known computer systems that include processors, memory, inputs/outputs, communications ports, and appropriate hardware and software, such as operating instructions, applications, databases and processing instructions for accomplishing the functions described herein. Communications may in fact be accomplished by any electronic device that is useful to communicate electronic data over a suitable network, and may include cellular telephones, personal digital assistants, and the like, as now known or hereinafter developed.

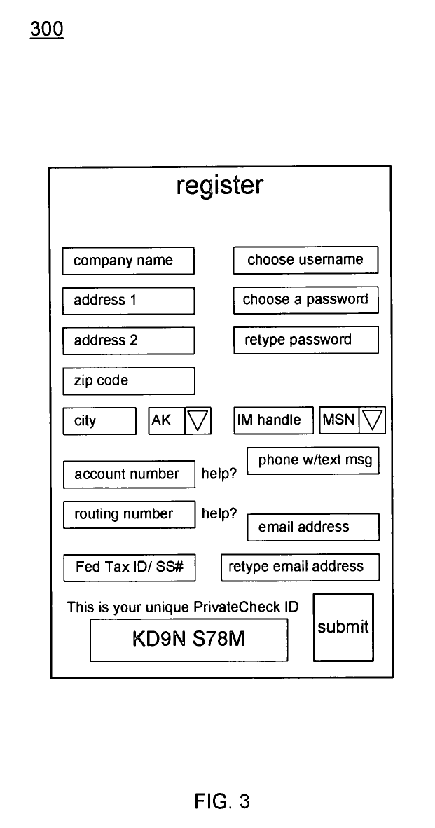

With reference to FIG. 1, therein is depicted an exemplary process 100 for registering with the PRIVATECHECK service and initiating a payment transaction according to the present disclosure. The process 100 commences when a customer registers with a provider of the PRIVATECHECK service described herein (step 101). This may be accomplished by entering the information shown in the exemplary customer registration screen 300 of FIG. 3. The customer enters their name (e.g., business or personal name), address (including postal and email addresses), business checking account number/bank routing number and other necessary bank account and personal/business information (such as taxpayer ID or social security number). The customer also selects a password for accessing and using the generated account.

Upon confirmation of the entered customer information (such as by the well-known techniques of confirming through communication via the customer's entered e-mail address and/or by independent credit checks and the like), the provider of the PRIVATECHECK service generates a unique identifier, such as a multi-digit alphanumeric code (example: KD9NS78M), preferably, but not limited to, a size of at least eight characters, which uniquely identifies the business and their account (step 102), and which can not be re-used to identify other customers. In various embodiments, the customer identifier may be a universally unique identifier as described in co-pending U.S. patent application Ser. No. 10/653,391, the entirety of which is incorporated herein by reference. In such embodiments, or in varieties thereof, the customer identifier may be generated by encoding customer information or data associated with the registration of the customer, according to any of a variety of well-known encoding techniques now known or hereinafter developed. The code may be guaranteed to be universally unique by encoding a unique property of the customer registration information in the customer identifier as described in the referenced application.

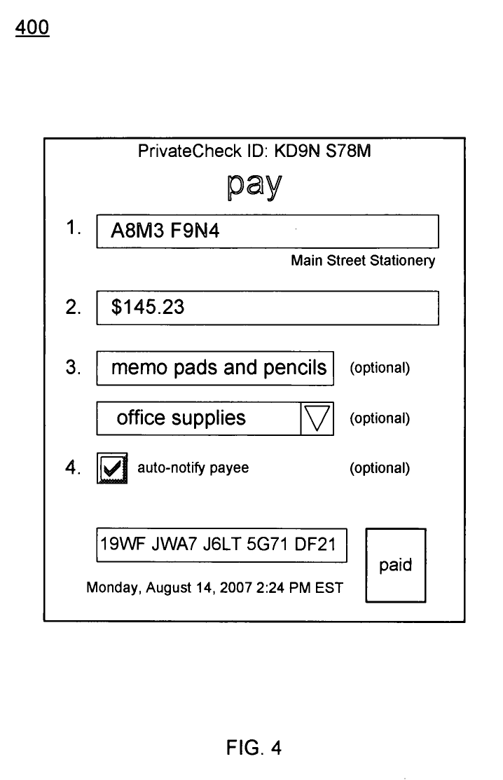

Returning to the process 100, the customer may then initiate a payment transaction by first logging into a website of the PRIVATECHECK service of the like, entering their customer identifier and password (step 103), and selecting a “make payment” (or similarly identified) function. The customer may then be presented with an exemplary transaction initiation screen 400, as depicted in FIG. 4.

Next, at step 104, the customer enters in similar information that they would typically use for a paper check, namely, a payee, a payment amount and notes or memoranda concerning the payment, and may also select to automatically notify (by e-mail or the like) the payee of the initiated transaction. It should be noted that, unlike the information on a paper check, the payee information will comprise a customer identifier of the payee, which is the payee's unique alphanumeric identifier that may also assigned to the payee in the manner described above with respect to step 102.

Upon confirmation of the entered transaction information, the customer selects a function by which the transaction is authorized and executed, upon which a unique transaction identification code is generated by the provider of the PRIVATECHECK service (step 105). Namely, the PRIVATECHECK service generates a unique (preferably, but not limited to, 12-20 digits) alphanumeric transaction identification code (e.g., 19WFJWA7J6LT5G71DF21), which uniquely identifies that particular transaction and is tied only to the payee's customer identifier so that other parties can not intercept and use the transaction code for their own accounts. In various embodiments, the transaction identifier may be a universally unique identifier (UUI) as described in co-pending U.S. patent application Ser. No. 10/653,391, the entirety of which is incorporated herein by reference. In such embodiments, or in varieties thereof, the transaction identifier may be generated by encoding payer, payee, or transaction information, according to any of a variety of well-known encoding techniques now known or hereinafter developed. The code may be guaranteed to be universally unique by encoding a unique property of the transaction data, as described in the referenced application, such as: date/time, payer/payee code, transaction amount, memoranda or note information, Internet Protocol (IP) address of the initiating party, session identifier (ID) of the initiating party, and the like).

Next, at step 106, the customer communicates the transaction identifier to the payee. In one embodiment, the customer may print a check that includes the transaction identifier in place of bank/routing number on an otherwise standard paper check. The customer may have the PRIVATECHECK service automatically notify the payee of the transaction identifier by e-mail or the like, or may otherwise communicate the transaction identifier to the payee themselves.

Finally, at step 107, the customer may download the transaction data directly to their accounting software or enter the same in any of a variety of useful and well-known manners, after which the process 100 ends.

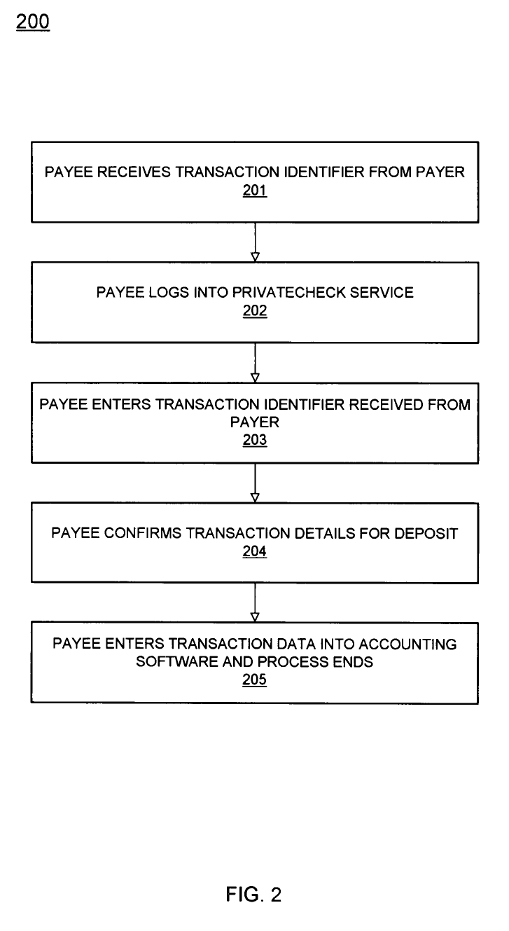

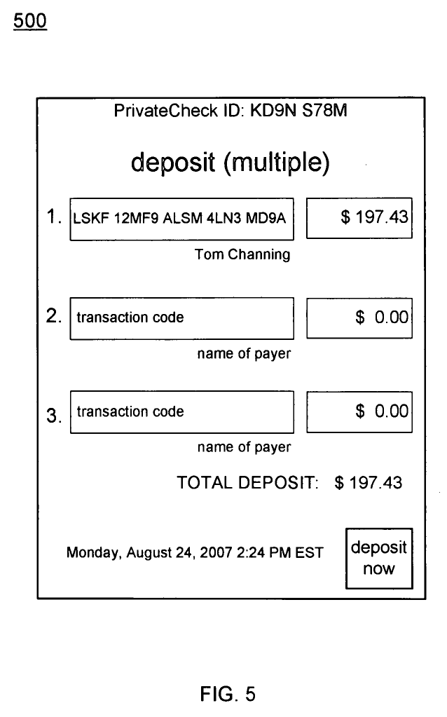

Turning now to FIG. 2, therein is depicted an exemplary process 200 performed by a payee for entering a deposit via the PRIVATECHECK SERVICE. The process 200 begins when a payee receives a transaction identifier from a payer (step 201). The payer logs into the PRIVATECHECK service using their customer identifier (generated in the manner described for step 102 above) and password (step 202), and selects a “deposit” (or similarly identified function). The payee may then be presented with an exemplary deposit screen 500, as depicted in FIG. 5. The payee needs only enter therein the received transaction code (step 203), and if the PRIVATECHECK service confirms that the transaction identifier corresponds to the payee entering the same, the payee is asked to verify the transaction information (such as payer, transaction amount, memo, and the like) presented by the PRIVATECHECK service form the records for the transaction. Next, at step 204, the payee confirms the deposit, and downloads or otherwise enters the completed transaction into their accounting software (step 205), after which the process 200 ends.

The PRIVATECHECK service accomplishes actual payment by processing a financial transfer of funds from the underlying actual bank account of the payer to the actual underlying bank account of the payee, as stored during the registration processes of both parties. The funds transfer may be accomplished using well known Automatic Clearing House (ACH) payment networks, or the like, as now known or hereinafter developed.

For small business owners and accountants who write and deposit numerous paper checks monthly, PRIVATECHECK is a secure, electronic payment service that provides privacy, accuracy, and time/cost savings that bank wires, credit cards, or check cards cannot provide. PRIVATECHECK provides the complete digital alternative to paper checks and fits within current small business payment processes.

Providers of the PRIVATECHECK service, such as banks, financial institutions, or other third parties, may offer free “check replacement” to customers for a flat fee per transaction, in order to encourage participation in the PRIVATECHECK service. PRIVATECHECK may be an application service provider to banks who pay licensing fees to be able to offer the PRIVATECHECK feature to their customers. PRIVATECHECK may also charge a flat transaction fee per transaction to the party making payment for the privacy protection. The provider of the PRIVATECHECK service may earn interest on the “float” of funds between the time payment is made and the time that the payee makes the deposit and this withdraws funds into their own bank account.

In sum, the PRIVATECHECK service described herein may provide the following benefits: (1) privacy, in that neither party to a transaction has to reveal their checking account number or bank routing number to the other; (2) accuracy, in that the unique customer identifiers eliminate many errors due to misspellings of payee name and the like, because PRIVATECHECK double checks that the payee entering in the transaction code is indeed the same as the payee intended by the payer, and the transaction code may incorporate this confirming information; (3) convenience, in that it is easy to write the check by typing in information (same fields of info as a regular check, except the payee field is filled in with the 8-digit identifier of the payee instead of the name of the business); (4) speedy deposit, in that there are no paper checks to endorse and deposit physically at the bank; (5) cost effective, in that a flat fee per transaction can be offered, there is no more handling paper checks, and payees can make deposits by entering in transaction code online in either case; and (5) data may be easily downloaded into customer's existing accounting software from the PRIVATECHECK service.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for initiating a transaction, comprising:
registering a payer;
providing a unique customer identifier for the payer;
receiving, from the payer, an initiation of a payment to a payee, including a unique customer identifier of the payee and a transaction amount; and
providing a unique transaction identifier for the payment to the payer for communication to the payee.

2. The method of claim 1, further comprising:
receiving the unique transaction identifier from the payee; and
transferring funds corresponding to the payment from the bank account of the payer to a bank account of the payee.

3. The method of claim 1, wherein the unique customer identifier of the payer comprises a universally unique identifier.

4. The method of claim 1, wherein the unique customer identifier of the payee comprises a universally unique identifier.

5. The method of claim 1, wherein the unique transaction identifier comprises a universally unique identifier.

6. The method of claim 1, wherein the unique customer identifier comprises an alphanumeric code of at least eight characters.

7. The method of claim 1, wherein the unique transaction identifier comprises an alphanumeric code of at least twelve characters.

8. The method of claim 1, wherein the unique customer identifier of the payer is generated by encoding registration information of the payer.

9. The method of claim 1, wherein the unique customer identifier of the payee is generated by encoding registration information of the payee.

10. The method of claim 1, wherein the unique transaction identifier is generated by encoding corresponding transaction information.

11. The method of claim 1, wherein said registering comprises receiving, from the payer: a name, an address, and the bank account of the payer.

12. The method of claim 1, further comprising receiving from the payee, an initiation of a deposit, including a unique transaction identifier.

13. The method of claim 12, further comprising receiving from the payee, an initiation of a deposit, including a unique transaction identifier and transaction amount.

14. A method for initiating a transaction, comprising:
registering a payer;
providing a unique customer identifier for the payer; wherein the customer identifier can only be used by a third party to make a deposit to a bank account of the payer and the customer identifier does not include an actual bank account number of the payer in human-readable format;
receiving, from the payer, an initiation of a payment to a payee, including a unique customer identifier of the payee and a transaction amount; and
providing a unique transaction identifier for the payment to the payer for communication to the payee.

15. A method for initiating a transaction, comprising:
registering a payer;
providing a unique customer identifier for the payer, wherein the customer identifier can only be used by a third party to make a deposit to a bank account of the payer and the customer identifier does not include an actual bank account number of the payer in human-readable format;
receiving, from the payer, an initiation of a payment to a payee, including a unique customer identifier of the payee and a transaction amount; and
providing a unique transaction identifier for the payment to the payer for communication to the payee; and
associating the unique transaction identifier with the unique customer identifier of the payee, so that only the payee may use the unique transaction identifier to accomplish a deposit of the payment.

16. The method of claim 15, further comprising:
receiving, from the payee, an initiation of a deposit, including a unique transaction identifier.
